(19) United States
(12) Patent Application Publication
(10) Pub. No.: US 2006/0158323 A1
(43) Pub. Date: Jul. 20, 2006

(54) Vehicle warning system

(76) Inventors: Robert J. Pattison, Durand, WI (US); Gregory A. Prissel, Durand, WI (US); Graham E. Anderson, Minneapolis, MN (US); Daren J. Luedtke, Macomb, MO (US)

Correspondence Address: MERCHANT & GOULD PC, P.O. BOX 2903, MINNEAPOLIS, MN, 55402-0903, US

(21) Appl. No.: 11/293,029

(22) Filed: Dec. 2, 2005

Related U.S. Application Data
(60) Provisional application No. 60/633,663, filed on Dec. 4, 2004.

(51) Int. Cl. B60Q 1/00; B60Q 1/50; G08B 21/00

(52) U.S. Cl. 340/440; 340/467; 340/436; 340/669

(57) ABSTRACT

A warning system for vehicles includes a controller and a light arrangement mounted to a vehicle. The controller includes a g force sensor configured to measure a g force value being exerted on the vehicle. The light arrangement is operationally coupled to the controller and is configured to flash at different flash rates based on the measured g force values sensed by the controller. The controller can be operationally coupled to a brake light sensor and can be numerically leveled upon activation of the brake light sensor.

### CROSS-REFERENCE TO RELATED APPLICATIONS

This application claims the benefit of U.S. Provisional Application No. 60/633,663, filed Dec. 4, 2004, the contents of which are herein incorporated by reference.

### BACKGROUND

The stopping and starting of “bumper to bumper” traffic during travel on highways and roads during “rush hour” or during a “traffic jam” is a source of risk of vehicle collisions. A driver may not notice that a proceeding car is decelerating until it is too late to act. In addition, a driver may be unable to judge how quickly or to what extent the proceeding car is decelerating.

Normally, a vehicle traveling in such traffic is warned that a preceding car is decelerating when the brake lights of the preceding car are illuminated. Typically, the brake lights illuminate with a constant intensity while the brake pedal is depressed and darken when the brake pedal is released.

There is a need for additional improvements to further assist in the prevention of vehicle collisions.

### SUMMARY OF THE INVENTION

In general terms, this patent relates to a vehicle warning system.

One aspect provides a vehicle warning system including a controller and a light bar arrangement. The controller is mounted to a vehicle and includes a g force sensor. The g force sensor is configured to measure a g force value being exerted on the vehicle. The controller is configured to compare the measured g force value to at least a first threshold value and a second threshold value. The light bar arrangement is mounted to the vehicle and operationally coupled to the controller. The light bar arrangement is configured to flash at a first flash rate if the controller determines that the measured g force value is intermediate the first threshold value and the second threshold value and to flash at a second flash rate if the controller determines that the measured g force value equals or exceeds the second threshold value.

Another aspect provides a method for warning trailing vehicles of rapid deceleration of a leading vehicle. The method includes sensing activation of a vehicle brake light system of the leading vehicle, obtaining a first g force value of the leading vehicle when the activation is sensed, and obtaining a second g force value of the leading vehicle. The method further includes comparing the second g force value to the first g force value and illuminating at least a portion of a light bar arrangement viewable to at least one trailing vehicle if a difference between the second g force value and the first g force value exceeds a first threshold value.

### BRIEF DESCRIPTION OF THE DRAWINGS

These and other advantages of the present invention are best understood with reference to the drawings, in which:

FIG. 1 is a block diagram of a vehicle warning system according to one embodiment of the present disclosure;

FIG. 2 is a diagrammatic view of one side of the housing of a controller according to one embodiment of the present disclosure;

FIG. 3 is a schematic diagram of a light bar arrangement according to one embodiment of the present disclosure;

FIG. 4 is a chart of one illumination sequence for the vehicle warning system according to one embodiment of the present disclosure;

FIG. 5 is a diagrammatic view of a second side of the housing of the controller shown in FIG. 2 according to one embodiment of the present disclosure;

FIG. 6 is a circuit diagram for a vehicle warning system according to one embodiment of the present disclosure;

FIG. 7 is a circuit diagram for another vehicle warning system according to one embodiment of the present disclosure;

FIG. 8 is a top view of the additional embodiment of the vehicle warning system controller according to one embodiment of the present disclosure;

FIG. 8A illustrates an output plug of a controller configured to transmit output to a light bar arrangement according to one embodiment of the present disclosure;

FIG. 9 is a side view for the additional embodiment of the vehicle warning system controller according to one embodiment of the present disclosure;

FIG. 10 a wiring diagram for a circuit layout of an alternative embodiment of controller according to one embodiment of the present disclosure;

FIG. 11 is a wiring diagram for a threshold circuit configuration according to one embodiment of the present disclosure;

FIG. 12 is a partial component layout and wiring diagram for the second printed circuit board PCB2 shown in FIG. 9 of the alternative controller according to one embodiment of the present disclosure;

FIG. 13 is a circuit diagram of an optional voltage regulator that can be used in the circuits implementing embodiments of the present disclosure; and

FIG. 14 is a circuit diagram of an optional circuit enabling the alternative controller to provide visual confirmation of when the circuit is leveling the g force sensor according to one embodiment of the present disclosure.

### DETAILED DESCRIPTION

A vehicle warning system warns a trailing vehicle that a leading vehicle is rapidly decelerating. In some embodiments, the warning system alerts a driver of a trailing vehicle to the severity and rate of deceleration of a leading vehicle. In the following description, for purposes of explanation, numerous specific details are set forth in order to provide a thorough understanding of the present invention. It will be evident, however, to one skilled in the art that the present invention may be practiced without these specific details.

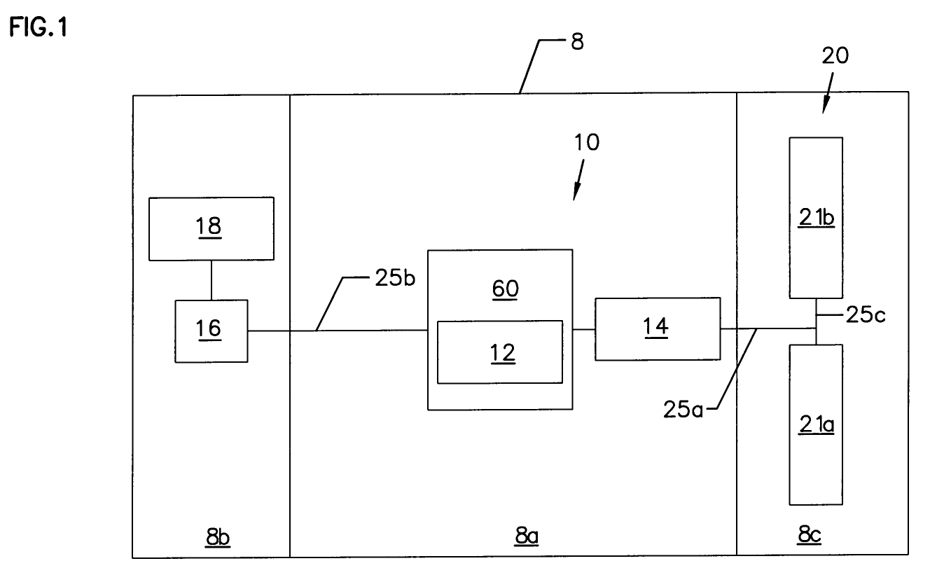

Referring to FIG. 1, one exemplary embodiment of a vehicle warning system 10 is shown. The vehicle warning system 10 includes a controller 60 and a light bar arrangement 20. Although a light bar arrangement is shown, it can be readily appreciated that other light arrangements, such as may be used within the vehicle industry, are also within the scope of the invention. The controller 60 includes a g force sensor 12 configured to measure the g force exerted on a vehicle 8. When the g force exerted on the vehicle 8, as measured by the g force sensor 12, exceeds a first pre-programmed threshold, the controller 60 sends a signal to the light bar arrangement 20 causing the light bar arrangement 20 to illuminate. In one embodiment, the controller 60 signals the light bar arrangement 20 to turn off when the g force sensor 12 determines that the g force being exerted on the vehicle 8 has dropped below the first threshold level. In another embodiment, the controller 60 signals the light bar arrangement 20 to turn off when the g force sensor 12 determines that the g force being exerted on the vehicle 8 has dropped below another pre-programmed level.

In general, the g force exerted on a vehicle 8 varies based on the topography and resistance of the road over which the vehicle is traveling. For example, a vehicle will typically experience negative g force values when traveling downhill and positive g force values when traveling uphill. In some embodiments, leveling the g force reading of the g force sensor 12 enables a more accurate measurement of the increase in the g force exerted on the vehicle. For the purposes of this disclosure, leveling the g force refers to determining the increase in g force in reference to a base g force value.

Leveling the g force reading includes comparing a current g force measurement against a base g force value. In some embodiments, the base g force value is zero. In other embodiments, the base g force is established during the course of travel. In a preferred embodiment, the controller 60 sets the base g force value to the value of the g force being exerted on the vehicle 8 when the vehicle 8 begins to decelerate. Subsequent g force readings are then compared against the newly set base g force value.

The controller 60 is configured to mount to a vehicle 8. In some embodiments, the controller 60 is portable, enabling after market installation of the controller 60. In other embodiments, the controller 60 can be installed during the vehicle manufacturing process. In a preferred embodiment, the controller 60 mounts to the passenger compartment 8a of the vehicle 8. However, in other possible embodiments, the controller 60 may mount to the engine compartment 8b and the trunk area 8c of the vehicle 8. In still other possible embodiments, the controller 60 may mount to an exterior of the vehicle 8. In one possible embodiment, the wiring harness 25a extends from one end of the vehicle 8a to the other end 8c, thereby allowing installation of the controller 60 in the engine compartment 8b and the light bar apparatus 20 on the rear of the vehicle 8c.

In some embodiments, the controller 60 is electrically coupled to the light bar arrangement 20 via a wiring harness 25a and to a power source 18 via a power feed wiring harness 2b. In other embodiments, wiring harness couplers 14, 16 are interposed between the light bar arrangement 20, the controller 60, and the power source 18, respectively. In a preferred embodiment, the power source 18 is a 12-volt DC power source available within the vehicle 8, such as the fuse box (not shown).

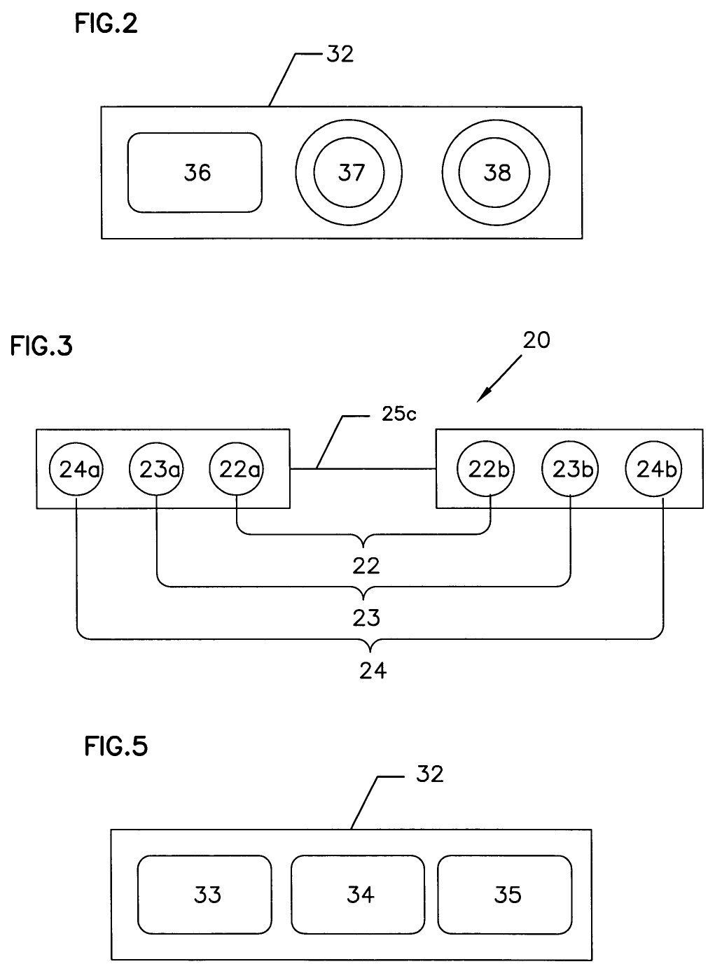

Referring to FIG. 2, there is illustrated a side view of one exemplary embodiment of the controller 60 including a housing 32. The housing 32 includes a lamp arrangement input/output port 36, a voltage input port 37, and a programming port 38. The light bar arrangement input/output port 36 enables the controller 60 to send signals to and receive signals from the light bar arrangement 20. The voltage input port 37 enables the controller 60 to receive electrical power from the power source 18. The programming port 38 enables programming instructions to be input to the controller 60.

Referring to FIG. 3, one exemplary embodiment of the light bar arrangement 20 includes at least two light bars 21a, 21b viewable to a trailing vehicle. In a preferred embodiment, the light bars 21a, 21b are mounted to a rear of the vehicle 8. In some embodiments, the light bars 21a, 21b are electrically coupled by a wiring harness 25c.

In some embodiments, each light bar 21a, 21b includes multiple lamps capable of operating independently of one another. In a preferred embodiment, each light bar 21a, 21b includes at least an inner lamp 22a, 22b, a center lamp 23a, 23b, and an outer lamp 24a, 24b, thereby forming first, second, and third lamp pairs 22, 23, 24, respectively. In other possible embodiments, the lamps 22a-24b are individually controlled and do not operate in pairs.

The controller 60 operates the lamps 22a-24b of the light bar arrangement 20. In some embodiments, the controller 60 stores an activation threshold value and a deactivation threshold value for each lamp pair 22-24. Each lamp pair 22-24 illuminates when g force exerted on the vehicle 8 reaches the activation threshold and turns off when the g force exerted on the vehicle 8 reaches the deactivation threshold. In some possible embodiments, multiple activation and deactivation thresholds may be programmed into the controller 60, each activation and deactivation threshold corresponding with a different lamp pair.

In some embodiments, the vehicle warning system 10 enters a different mode of operation for each g force threshold met or exceeded by the vehicle 8. Each mode of operation activates a different illumination sequence of the light bar arrangement 20. In some embodiments, an illumination sequence includes the illumination of a particular pair or pairs 22-24 of lamps on the light bar arrangement 20 flashing at a unique flash rate. In other embodiments, an illumination sequence includes the illumination of a particular set of lamp pairs 22-24 flashing at a unique flash rate. In still other embodiments, the illuminated lamp pairs may flash at different flash rates.

In some embodiments, the vehicle warning system 10 has four modes of operation. However, in other embodiments, a vehicle warning system may have more or fewer modes of operation without deviating from the teachings and scope of the present invention. In one embodiment, the first mode of the vehicle warning system 10 activates when the brake lights of the vehicle 8 activate. All of the lamps 22a-24b of the light bar arrangement 20 remain deactivated during the first mode.

In some embodiments, the g force sensor 12 activates when the vehicle warning system 10 enters the first mode of operation. In other possible embodiments, the g force sensor 12 activates when the vehicle ignition is activated. During the first mode of operation, the controller 60 establishes a base g force value. In one exemplary embodiment, the controller 60 sets the base g force value as the current value being sensed by the g force sensor 12. In one embodiment, the controller 60 sets the base g force value when the brake lights of the vehicle 8 activate. Values of all subsequent g force measurements are determined with reference to the base value.

The second, third, and fourth modes of operation of the vehicle warning system 10 are activated when the g forces exerted on the vehicle 8 exceed a first, second, and third g force threshold level, respectively. In some embodiments, each g force threshold level is preprogrammed into the controller 60. In one embodiment, the controller 60 stores a first activation threshold setting A, a second activation threshold setting B, and a third activation threshold setting C, where A is less than B, B is less than C, and C is the greatest g force threshold setting.

In some embodiments, the vehicle warning system 10 initializes in the first mode of operation and enters the second mode of operation when the controller 60 determines that a measured g force value is equal to or greater than the first activation threshold setting A, but less than the second activation threshold setting B. Entering the second mode of operation causes a first set of lamp pairs 22-24 of the light bar arrangement 20 to illuminate. In one embodiment, entering the second mode of operation causes the inner lamp pair 22 to illuminate.

In some embodiments, the vehicle warning system 10 enters the third mode of operation when the controller 60 determines that the measured g force value is equal to or greater than the second activation threshold value B, but less than the third activation threshold value C. Entering the third mode of operation causes a second set of lamp pairs 22-24 of the light bar arrangement 20 to illuminate. In one example embodiment, entering the third mode of operation causes the inner and center lamp pairs 22, 23 to illuminate.

In some embodiments, the vehicle warning system 10 enters the fourth mode of operation when the controller 60 determines that the measured g force value is equal to or greater than the third activation threshold setting C. Entering the fourth mode of operation causes a third set of lamp pairs 22-24 of the light bar arrangement 20 to illuminate. In one example embodiment, entering the fourth mode of operation causes the inner, center, and outer lamp pairs 22-24 to illuminate.

In some embodiments, the second, third, and fourth modes of operation cause the lamp pairs 22-24 to flash according to first, second, and third flash sequences L, M, N, respectively. Each flash sequence L, M, N includes a flash rate and a flash order. The flashing sequence N of the fourth mode of operation overrides the flashing sequences L, M of the previous modes of operation. The flashing sequence M of the third mode of operation overrides the flashing sequence L of the second mode of operation.

In a preferred embodiment, only the inner lamp pair 22 begins a first preprogrammed flashing sequence L in the second mode of operation. The inner and center lamp pairs 22, 23 begin a second preprogrammed flashing sequence M in the third mode of operation. The innermost lamp pair 22 does not continue to flash according to sequence L, but rather begins to flash according to sequence M along with the center lamp pair 23. In the fourth mode of operation, all lamp pairs 22-24 illuminate and flash according to a third flashing sequence N. Of course, in other embodiments, each lamp pair may continue to flash according to the pre-programmed flash sequence associated with the mode of operation in which the lamp pair is first illuminated.

In some embodiments, the urgency of the situation to the trailing vehicle driver (e.g., the rate and magnitude of the deceleration of the leading vehicle) is conveyed in the quantity of lamps illuminated and the flash rate and sequence of illumination of the light bar arrangement 20. In one embodiment, the flashing rate of the light bar arrangement 20 increases corresponding to the amount of increase in g forces exerted on the vehicle 8. For example, in one embodiment, flash sequence N is faster than flash sequence M and flash sequence M is faster than flash sequence L.

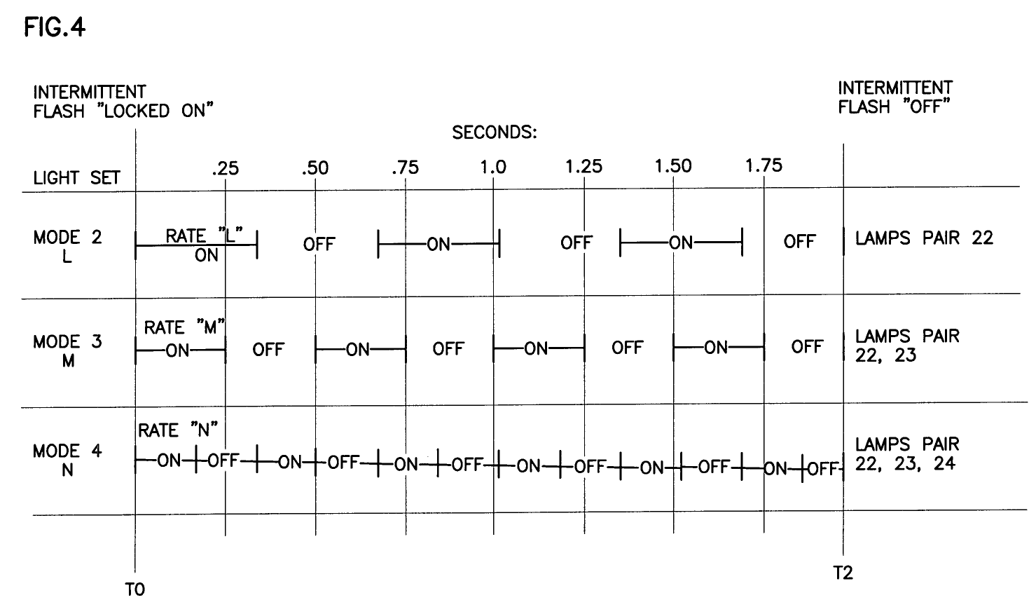

Referring to FIG. 4, an exemplary rate of flash for the second, third, and fourth modes of operation is provided. In general, different modes of operation are shown over a time period of 2 seconds, from time T0 to time T2. The chart assumes that the g force reading from the g force sensor 12 is reaches or exceeds the threshold value for each respective mode of operation at time T0 and drops below the threshold value at time T2. The chart is broken horizontally into time periods of 0.25 seconds.

For example, in some possible embodiments, the flash sequence L is the “lowest” warning rate in which only the innermost lamps 22a, 22b on the light bar apparatus 20 flash at a slow rate. In the illustrated embodiment, the innermost lamps 22a, 22b turn on when the first threshold value A is met or exceeded and remain on for 0.35 seconds. The innermost lamps 22a, 22b then turn off for 0.35 seconds. This sequence is repeated until the g force sensor reading exceeds the second threshold value B or drops below the first threshold value A.

In some embodiments, the flash sequence M is the mid-range warning rate in which the innermost lights 22a, 22b and center lights 23a, 23b of the light bar apparatus 20 flash at a faster pace than in flash sequence L. In the example embodiment shown in FIG. 4, the innermost lights 22a, 22b and center lights 23a, 23b turn on when the second threshold value B is met or exceeded and remain on for 0.25 seconds. The innermost lights 22a, 22b and center lights 23a, 23b then turn off for 0.25 seconds. This sequence is repeated until the g force sensor reading exceeds the third threshold value C or drops below the second threshold value B.

In some embodiment, the flash sequence N is the highest level of warning in which all lamp pairs 22-24 on the light bar arrangement 20 flash at the greatest flash rate. In the example embodiment shown in FIG. 4, all three lamp pairs 22-24 turn on when the third threshold value C is met or exceeded and remain on for 0.15 seconds. The lamp pairs 22-24 then turn off for 0.15 seconds. This sequence is repeated until the g force sensor reading drops below the threshold value C.

Referring now to FIG. 5, in one exemplary embodiment, the controller 60 includes first, second, and third input acceptors 33, 34, 35, respectively to program the threshold values into the controller 60. Of course, in other embodiments, the threshold values could be hardwired into the controller 60 and cannot be changed. In one embodiment, the input acceptors 33, 34, 35 are buttons arranged on a side of the housing 32 opposite the side depicted in FIG. 2. In some embodiments, the first input acceptor 33 includes a mode button, the second input acceptor 34 includes an increment button, and the third input acceptor 35 includes a decrement button.

In general, pressing the mode button 33 causes the controller 60 to cycle through settings for each mode of operation. In one embodiment, pressing the mode button 33 causes a display on the controller 60 cycles through the flash rate, activation threshold setting, and deactivation threshold setting for each mode of operation. In other embodiments, the mode button 33 can also be used to modify the flash rate and threshold values for each mode. In still other embodiments, pressing the mode button 3 sets the vehicle warning system 10 into the first mode of operation in which the g force sensor 12 obtains a base g force value and then iteratively measures the g force exerted on the vehicle 8.

In some embodiments, pressing the increment button 34 and the decrement button 35 once will increase and decrease, respectively, the value of the displayed setting by one numerical value. In one embodiment, pressing and holding down the increment button 34 or the decrement button 35 will adjust the values rapidly, repeatedly cycling through the possible numerical values.

In a embodiment, the controller 60 initializes in the first mode of operation. Thereafter, pressing the mode button 33 cycles the controller 60 to the next setting for each mode of operation and through each mode. For example, pressing the mode button 33 once cycles the controller 60 to a flash rate for the second mode of operation. Pressing the mode button 33 a second time cycles the controller 60 to the first activation threshold value. Pressing the mode button 33 a third time cycles the controller 60 to the deactivation threshold value for the second mode of operation. The flash rate and threshold value settings for the third and fourth mode of operation follow.

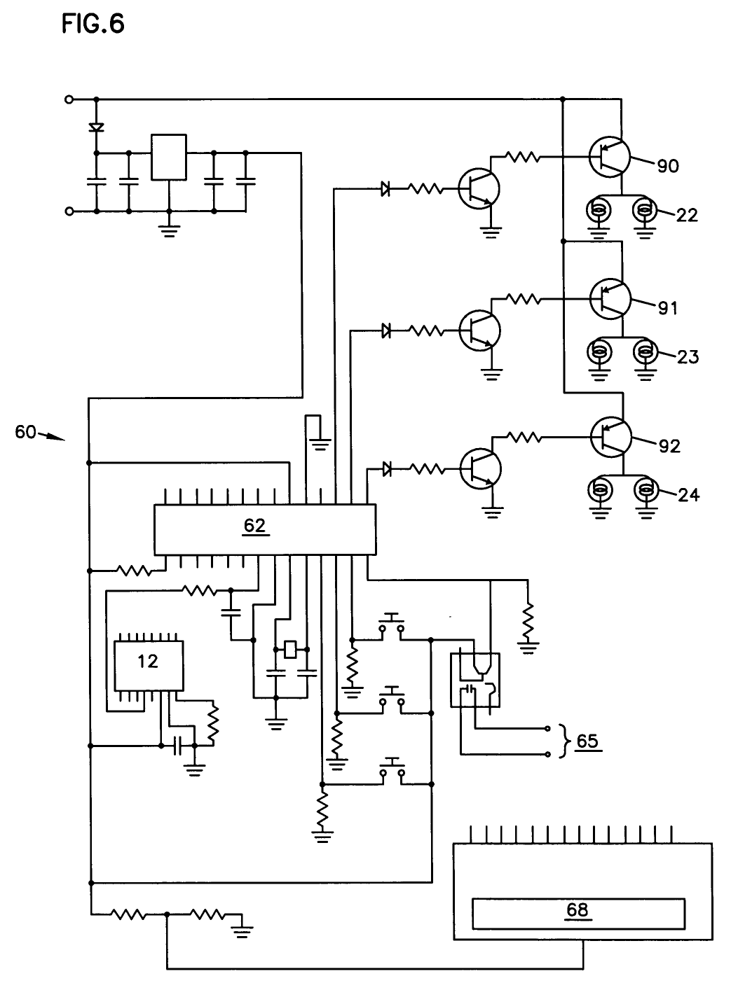

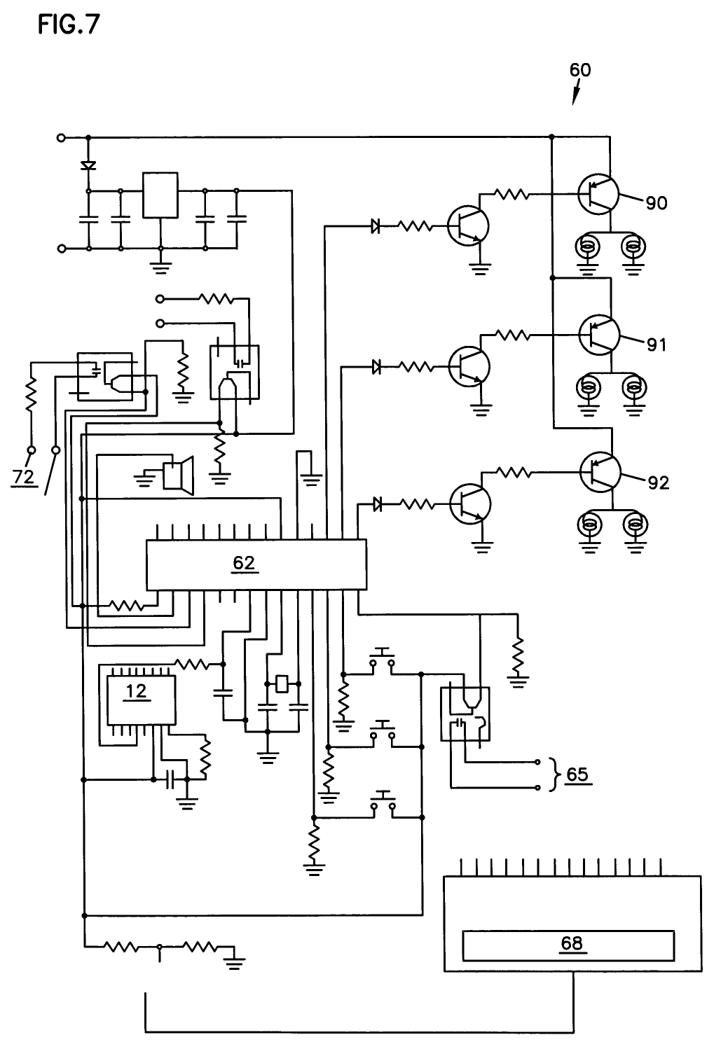

Referring to FIG. 6, a circuit diagram for one exemplary embodiment of a controller 60 is shown. The controller 60 is configured to be electrically coupled to the power source 18 via power connector 41 and to the light bar arrangement 20 via light bar circuits 90, 91, 92. The controller 60 is configured to operate the light bar arrangement 20. The controller 60 includes a g force sensor 12, a microprocessor 62, and a brake light sensor 65. In one embodiment, the controller 60 further includes a display screen 68.

The g force sensor 12 is configured to measure the g force exerted on a vehicle, such as vehicle 8 of FIG. 1. The microprocessor 62 is configured to operate the g force sensor 12 and to determine whether the g force exerted on the vehicle exceeds at least one preset threshold. One possible example of a suitable microprocessor 62 is model number PIC16F870-I/SP by Microchip Technology Inc. The microprocessor 62 is also operationally coupled to the brake light sensor 65. The brake light sensor 65 determines whether the brake lights of the vehicle have been activated.

Referring now to FIG. 7, in another embodiment, the controller 60 is configured to couple to one or more existing safety and operational equipment within a vehicle, such as vehicle 8 of FIG. 1. In various embodiments, the controller 60 can be coupled to the vehicle's air bag system, the vehicle's ABS or other braking system, and the vehicle's side impact sensors. In such embodiments, the microprocessor 62 of the controller 60 is configured to couple to an air bag system 70, an ABS, TCS, or AYC braking system 72, an audible alarm speaker 74, and external side impact sensor (not shown). Of course, in other embodiments, any desired sensors and vehicle systems could be coupled to the microprocessor 62.

In some embodiments, the activation of one or more of the existing safety or operational equipment 70, 72, 74 can activate one of the escalated modes of operation independent of the g force sensor readings. For example, in one exemplary embodiment, activation of a vehicle's brake lights 65 and reaching or exceeding the threshold preset activates the second mode of operation whereas activation of the vehicle's anti-lock brakes 72 can activate the third mode of operation. In another exemplary embodiment, the deployment of a vehicle's airbags 70 activates the fourth mode of operation of the controller 60.

In one embodiment, each wiring circuit connector 70, 72, 74, is coupled to a “female” connector (not shown) which is mounted through a housing, such as housing 32 of FIG. 2, of the controller 60 (shown in FIG. 3) and is configured to be coupled to a “male” connector (not shown) to create an electrical connection between the microprocessor 62 of the controller 60 and each of the external elements, such as the brake lights 65 and air bag system 70 (shown in FIG. 7), in the operation of the vehicle warning system 10.

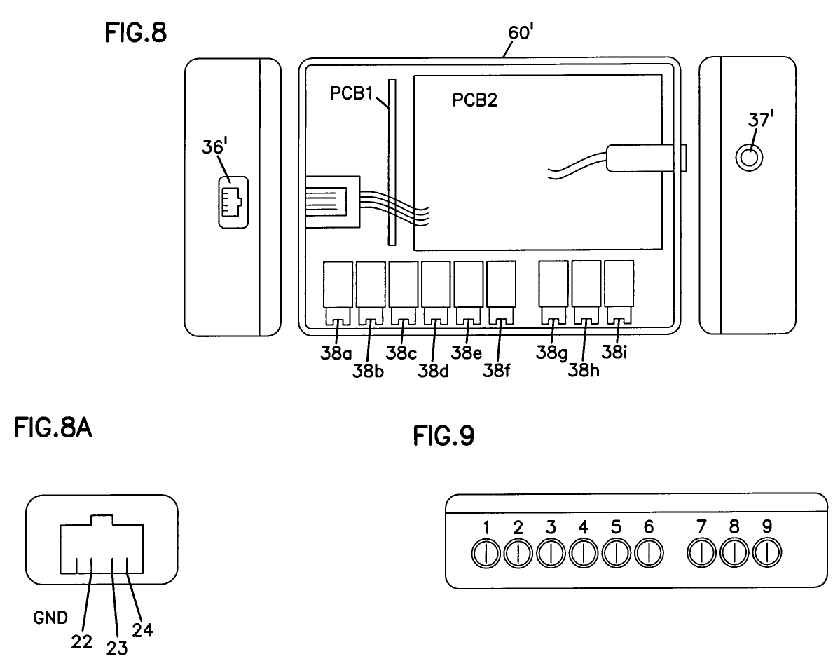

Referring now to FIGS. 8-12, a further embodiment of a controller is shown. FIG. 8 illustrates a controller 60′ including a first printed circuit board PCB1 and a second printed circuit board PCB2. The controller 60′ further includes a housing 32′ having a light bar connector 36′, a power input 37′, and programming inputs 38a-38i. The first printed circuit board PCB1 includes a g force sensor 18′. The second printed circuit board PCB2 includes electrical circuits configured to compare g force sensor readings with a base reading. The second printed circuit board PCB2 is further configured to control the lamps 22, 23, 24 on the light bar arrangement 20 based on the comparison.

FIG. 8A illustrates the light bar connector 36′ in further detail. In the illustrated embodiment, the light bar connector 36′ includes a ground connection G, and a connection for each lamp set 22, 23, 24. In one embodiment, the light bar connector 36′ is a RJ-11 connector.

FIG. 9 illustrates a side view of one exemplary embodiment of the controller 60′ including the programming adjusters 38a-38i. The illustrated embodiment is configured to operate a light bar arrangement 20 having three sets of lamps 22, 23, 24. Programming adjusters 38a, 38c, and 38e enable a user to set the deactivation threshold value when the first, second, and third lamp sets 22, 23, 24, respectively, darken. Programming adjusters 38b, 38d, and 38f enable a user to set the activation threshold value when the first, second, and third lamp sets 22, 23, 24, respectively, illuminate. Programming adjusters 38g, 38h, and 38i enable a user to set the flash rate of the first, second, and third flash sequences L, M, N, respectively. In the illustrated embodiment, rotating the adjusters, for example, via a flathead screwdriver, in a first direction increments the settings and rotating the adjusters in a second direction decrements the settings.

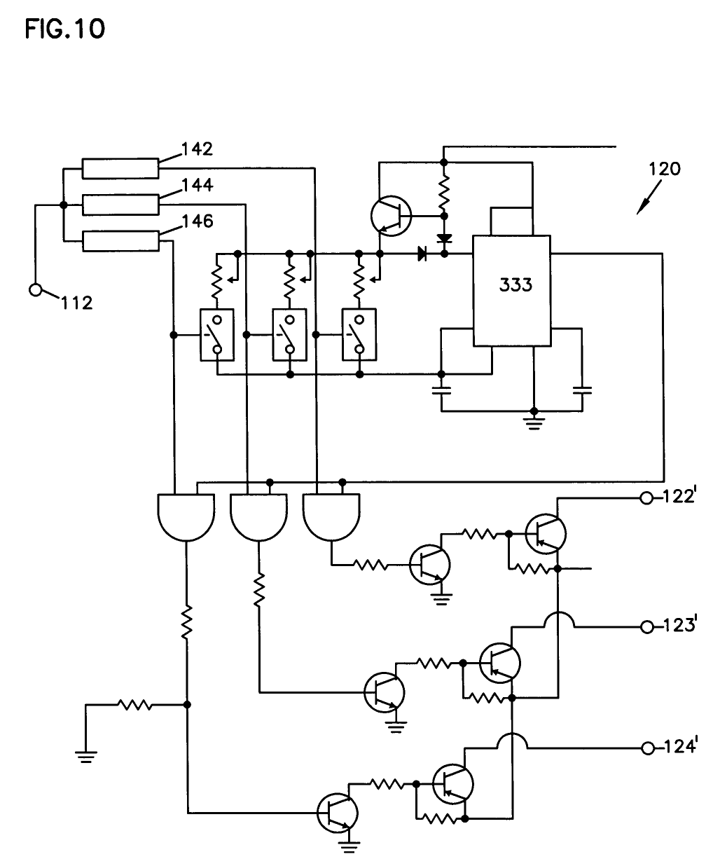

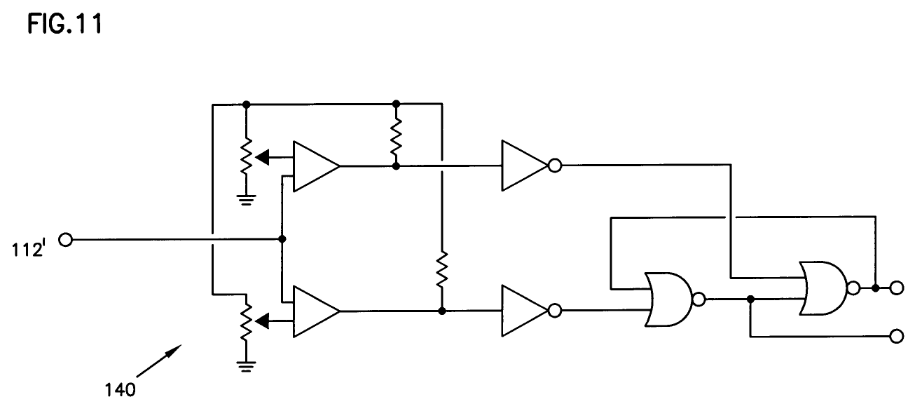

FIG. 10 illustrates one exemplary embodiment of a wiring diagram for a circuit layout 120 of controller 60′. The layout 120 includes a g sensor 112 to receive a g force sensor reading, a first threshold circuit configuration 142, a second threshold circuit configuration 144, and a third threshold circuit configuration 146. In one example embodiment, the g force sensor 112 includes a vehicle accelerometer. The threshold circuit configurations 142, 144, 146, respectively, control the thresholds at which the lamp pairs 22, 23, 24 activate and deactivate. The circuit layout 120 further includes outputs 122′, 123′, 124′ configured to electrically connect to first, second, and third lamp sets 22, 23, 24 (FIG. 3), respectively.

FIG. 11 illustrates a wiring diagram 140 for a threshold circuit configuration, such as threshold circuit configurations 142, 144, 146 of FIG. 10. The wiring diagram 140 includes a g sensor input 112′ and an output Q indicating whether the current g force meets or exceeds the threshold value.

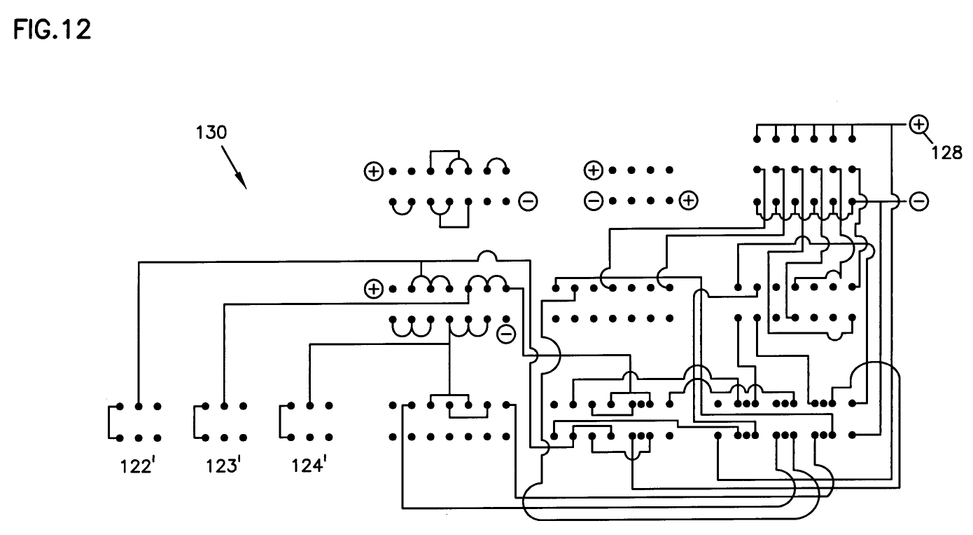

FIG. 12 illustrates a partial component layout 130 and wiring diagram for the second printed circuit board PCB2 of the alternative controller 60′. The layout 130 includes connectors to the power source 18 indicated at 128 and first, second, and third lamp set connectors 122′, 123′, 124′, respectively. FIG. 12 illustrates a partial wiring diagram for the circuit determining the flash rate of each lamp pair 22, 23, 24 (shown in FIG. 3).

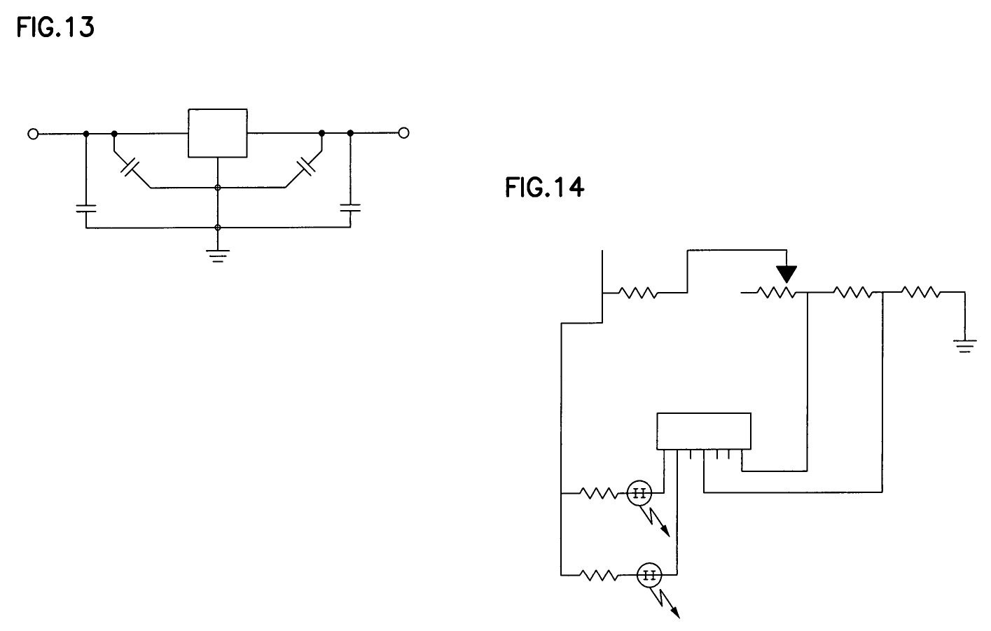

FIG. 13 illustrates an optional voltage regulator that can be used in the circuits shown in FIGS. 6, 7, and 12. FIG. 14 illustrates an optional circuit enabling the alternative controller 60′ to provide visual confirmation of when the circuit is leveling the g force sensor 12′. The circuit can be coupled to an LED or other display (not shown).

The above noted principles of the invention can best be understood with reference to an exemplary application.

In one embodiment, flash rate settings are displayed on the controller 60 in increments of one-tenth of a second and can range from about 0.01 second to about 4.5 seconds. Lamp pair 22-24 activation and deactivation threshold settings for each mode of operation are displayed in increments of one-hundredth of a g and can be set to any value from 0.0 to 1.27.

For example, if the first lamp pair 22 has a g force deactivation setting of about 0.10 g, a g force activation setting of about 0.34 g, and a flash rate setting of 1.0 seconds, then the first lamp pair 22 would iteratively illuminate for about one second and then darken for one second when the g force exerted on the vehicle 8 reached 0.10 g. If the second lamp pair 23 has a g force deactivation setting of about 0.34 g, a g force activation setting of about 0.40 g, and a flash rate setting of about 0.07 seconds, then the first and second lamp pairs 22, 23 would iteratively illuminate for 0.07 seconds and then darken for 0.07 seconds when the g force reading of the g force sensor 12 reached 0.40 g, overriding the flash rate setting of 1.0 seconds of the first lamp pair 22. If a third lamp pair 24 has a g force deactivation setting of about 0.40 g, a g force activation setting of about 0.45 g, and a flash rate setting of about 0.05 seconds, then the first, second, and third lamp pairs 22, 23, 24, respectively, would iteratively illuminate for 0.05 seconds and then darken for 0.05 seconds when the g force reading of the g force sensor 12 reached 0.45 g, overriding the flash rate setting of 0.07 seconds of the first and second lamp pair 22, 23, respectively.

The g force experienced by a vehicle 8 varies depending on the slope of the road on which the vehicle is traveling. Typically, therefore, the g force illumination and darken settings refer to normalized or calibrated g force values and not the actual g force exerted on the car. In particular, an offset value “g-” and a fractional numerical value “g*” are used to convert the actual g force value to a current g force value. In a preferred embodiment, the g force reading of the g force sensor 12 is sent to the microprocessor 62, which calculates the current g force value according to the following formula:
current g force=([g force sensor reading] −“g−”)*(1+“g.*”/256);
where “g.*” can be any value from 0 to 255 inclusively, generating 256 possible settings.

In one embodiment of the vehicle warning system, the following configuring of numerical values for each of the settings has been found to be satisfactory in the performance of the vehicle warning system. The first light pair 22 has a flash rate of 0.1 seconds, a first deactivation threshold of 0.1 g, and a first activation threshold of 0.35 g. The second light pair 23 has a flash rate of 0.07 seconds, a second deactivation threshold of 0.35 g, and a second activation threshold of 0.4 g. The third light pair 24 has a flash rate of 0.04 seconds, a third deactivation threshold of 0.4 g, and a third activation threshold of 0.45 g. In this embodiment, the “g−” value is equal to 0.59 and the “g.*” is equal to 1.58.

In this embodiment, the following code, which is written in JAL (Just Another Language developed by Wouter van Ooijen), is used to program the microprocessor 62 of the controller 60. Of course, the patent is not limited to this particular code or programming in the JAL language. The patent is limited in scope only by the claims appended hereto. Comments to the code are indicated by the symbol “--.”

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

The claims are:

1. A vehicle warning system comprising:
a controller mounted to a vehicle, the controller including a g force sensor configured to measure a g force value being exerted on the vehicle, the controller configured to compare the measured g force value to at least a first threshold value and a second threshold value; and
a light arrangement, the light arrangement operationally coupled to the controller, the light arrangement configured to flash at a first flash rate if the controller determines that the measured g force value is greater than or equal to the first threshold value and less than the second threshold value and to flash at a second flash rate if the controller determines that the measured g force value equals or exceeds the second threshold value.

2. The system of claim 1, wherein the light arrangement includes at least one light bar.

3. The system of claim 1, wherein the light arrangement includes at least a first light bar having at least one lamp pair.

4. The system of claim 3, wherein the light arrangement includes two light bars.

5. The system of claim 3, wherein each light arrangement includes at least a first and second lamp pair.

6. The system of claim 5, wherein the first lamp pair is configured to flash at the first flash rate and the second lamp pair is configured to flash at the second flash rate.

7. The system of claim 1, wherein the controller is portable.

8. The system of claim 1, wherein the light arrangement is configured to flash at a third flash rate if the measured g force value equals or exceeds a third threshold value.

9. The system of claim 1, wherein the controller is electrically coupled to a brake light system of the vehicle and is further configured to level the g force sensor when the brake light system activates.

10. The system of claim 1, wherein the controller is mounted in the front of the vehicle and the light arrangement is mounted to a rear of the vehicle.

11. The system of claim 1, wherein the controller is operationally coupled to an existing safety or operational system of the vehicle and wherein the light arrangement illuminates when the existing safety or operational system activates.

12. A method for warning trailing vehicles of deceleration of a leading vehicle, the method comprising:
sensing activation of a vehicle brake light system of the leading vehicle;
obtaining a first g force value of the leading vehicle when the activation is sensed;
obtaining a second g force value of the leading vehicle;
comparing the second g force value to the first g force value to obtain a difference; and
illuminating at least a portion of a light arrangement viewable to at least one trailing vehicle if the difference between the second g force value and the first g force value exceeds a first threshold value.

13. The method of claim 12, further comprising flashing the illuminated portion of the light arrangement at a flash rate.

14. The method of claim 12, further comprising:
illuminating a first lamp pair of the light arrangement when the difference equals or exceeds the first threshold value; and
illuminating the first lamp pair and a second lamp pair of the light arrangement when the difference equals or exceeds a second threshold value.

15. The method of claim 14, further comprising:
flashing the first lamp pair at a first flash rate when the difference equals or exceeds the first threshold value; and
flashing the first and second lamp pair at a second flash rate when the difference equals or exceeds the second threshold value.

16. The method of claim 14, further comprising:
illuminating the first lamp pair, the second lamp pair, and a third lamp pair of the light arrangement at a third flash rate when the difference equals or exceeds a third threshold value.
